(19) United States
(12) Patent Application Publication
(10) Pub. No.: US 2007/0289362 A1
(43) Pub. Date: Dec. 20, 2007

(54) Air scouring for immersed membranes

(76) Inventors: David Brian Ross, Burlington (CA); Fraser Charles Kent, Guelph (CA); Sarah Elhadi, Fredericton (CA)

Correspondence Address: BERESKIN AND PARR, 40 KING STREET WEST, BOX 401, TORONTO, ON, M5H 3Y2, US

(21) Appl. No.: 11/640,374

(22) Filed: Dec. 18, 2006

Related U.S. Application Data
(60) Provisional application No. 60/814,544, filed on Jun. 19, 2006.

(51) Int. Cl. B01D 65/02

(52) U.S. Cl. 73/38; 210/636; 210/639

(57) ABSTRACT

A method of cleaning filtering membranes involves scouring the membranes with bubbles while the lumens of the membranes contain a gas at pressure below the bubble point of the membranes. The method may be combined with an integrity test or chemical cleaning process also involving adding a gas to the lumens of the membranes. A tank containing the membranes may be full, draining, refilling, or at a lowered water surface level during the air scouring process. The membranes may be horizontally oriented and assume a concave downward shape during the scouring process.

This is an application claiming the benefit under 35 USC 119(e) of U.S. application Ser. No. 60/814,544 filed Jun. 19, 2006. U.S. application Ser. No. 60/814,544 is incorporated herein, in its entirety, by this reference to it.

### TECHNICAL FIELD

This invention relates to methods or apparatuses for cleaning or inhibiting the fouling of ultrafiltration or microfiltration membranes.

### BACKGROUND

Membranes may be used for separating a permeate lean in solids from a feed water rich in solids. One or more membranes may have a retentate side in fluid communication with the feed water and a permeate side at which permeate is collected. Filtered feed water may permeate through the walls of the membranes under the influence of a transmembrane pressure differential between the retentate side of the membranes and the permeate side of the membranes. Solids in the feed water are rejected by the membranes and remain on the retentate side of the membranes. The solids may be present in the feed water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others.

Over time, the solids foul the membranes which decreases their permeability. As the permeability of membranes decreases, the yield of the process similarly decreases or a higher transmembrane pressure is required to sustain the same yield. To prevent the decreased yield of the process or the increased transmembrane pressure from becoming unacceptable, the membranes may be cleaned. The cleaning may restore a portion of the permeability of the membranes or inhibit fouling of the membranes. Various methods of cleaning membranes are described in U.S. application Ser. No. 09/916,247. Various chemical cleaners are described in U.S. application Ser. No. 60/687,892, filed Jun. 7, 2005. U.S. application Ser. No. 09/916,247 and U.S. application Ser. No. 60/687,892 are incorporated herein, in their entirety, by this reference to them for the benefit of their disclosure although the invention claimed in this document is not limited by any statements in the incorporated documents.

Membranes may also be cleaned by using bubbles in water outside the membranes to scour or scrub the outer surfaces of the membranes and to move the membranes. Various cleaning methods using bubbles are described in International Publication No. WO 2005/082498 which is incorporated herein in its entirety for the benefit of its disclosure, although the invention claimed in this document is not limited by any statements in the incorporated document.

### SUMMARY

This specification describes a method or apparatus for cleaning filtering membranes. This specification also describes a method of scouring membranes with bubbles. Inventions may reside in various combinations or sub-combinations of elements or steps described in this summary or in other parts of this document, for example the figures or detailed description. This summary is intended to introduce the reader to the specification but not to define any invention. The invention or inventions protected by this document are defined in the claims.

A method of cleaning filtering membranes may include providing bubbles which rise past and contact a retentate side of the membranes. The tank may be filled with water to a level above the membranes or be in the process of being drained or filled or with a water level, either at a fixed elevation or at a varying elevation, that intersects the retentate side of the membranes, while the bubbles are provided. The membranes may be filled with air at a pressure below the bubble part of the membranes while the bubbles are provided. The membranes may be oriented horizontally. The air in the lumens make the fibers more, or more nearly, buoyant. This method of cleaning with bubbles may be combined with a method of cleaning with chemicals or testing the integrity of the membranes.

A process for cleaning membranes may comprise steps of (a) providing a gas in a cavity defined by an interior part of the membranes at a pressure below the bubble point of the membranes; and, (b) while performing step (a) providing bubbles from outside of the membranes which bubbles rise past and contact an exterior part of the membranes. The tank may be drained, filled or at a level below or above the top of the membranes during step (b). The pressurized gas may be provided from a gas supply that also supplies gas to a membrane integrity testing system. Step (b) may be performed for at least 10 minutes or for between 10 and 30 minutes. The process may be performed between twice per day and once per month. The process may further comprise draining a tank containing the membranes after steps (a) and (b). The process may further comprise a step of contacting the membranes with a chemical cleaner.

### BRIEF DESCRIPTION OF THE DRAWINGS

Examples of one or more methods or apparatuses will now be described with reference to one or more of the following figures.

FIG. 1 is a schematic diagram of a reactor having vertically oriented filtering membranes.

FIG. 2 is a schematic diagram of a portion of another reactor having horizontally oriented vertical membranes.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document and do not abandon, disclaim or dedicate to the public any such invention by its disclosure in this document.

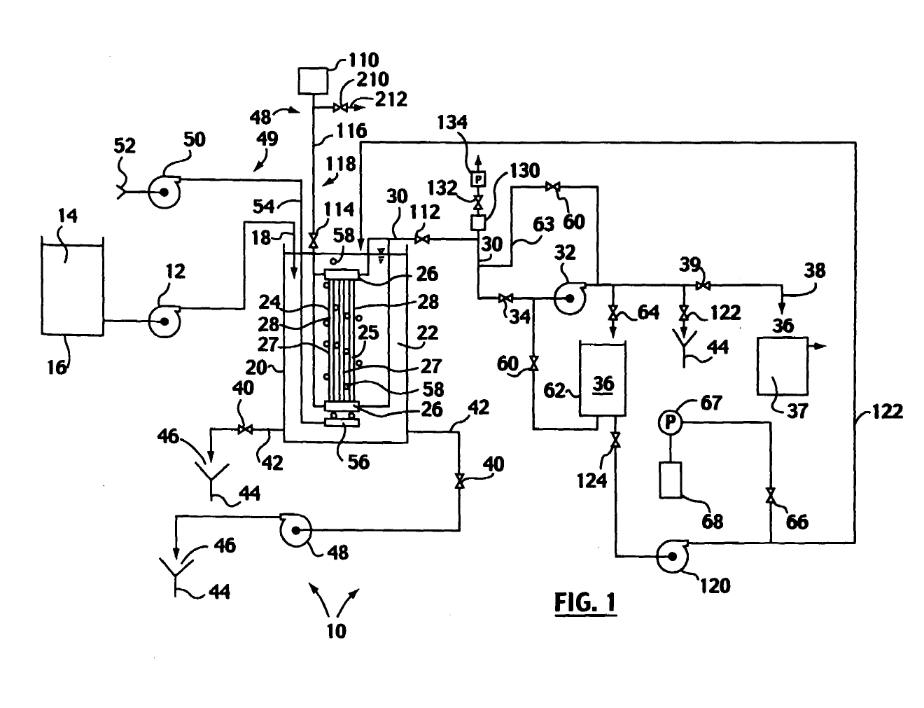

Referring now to FIG. 1, a reactor 10 is shown for treating a liquid feed having solids to produce a filtered permeate having a reduced concentration of solids and a retentate having an increased concentration of solids. Such a reactor 10 has many applications but will be described below as used for filtering water, for example, creating potable water from a supply of water such as well or surface water for a municipality, development or commercial use or for tertiary filtration or water reclamation, for example separating clean water from a waste water treatment plant, industrial process or agricultural discharge, or for separating clean water from a mixed liquor in a waste water treatment plant.

The reactor 10 includes a feed pump 12 which pumps feed water 14 to be treated from a water supply 16 through an inlet 18 to a tank 20 where it becomes tank water 22. If the process is being used, for example, for waste water treatment, tank water 22 may be referred to as mixed liquor and retained mixed liquor may be recycled, in whole or in part, to other parts of a treatment plant rather than being drained as will be described below. In this description, tank water 22 refers to both tank water 22 intended to be filtered for drinking, for example in dead end filtration, and mixed liquor or water to be filtered under a process including recycle to another tank. During permeation, the tank water 22 is generally maintained at a level which covers one or more membranes 24. Each membrane 24 has a permeate side 25 which does not contact tank water 22 and a retentate side 27 which does contact the tank water 22.

Membranes 24 made of hollow fibres are useful for their ability to provide a high surface area and withstand backwash pressures although the membranes 24 may be of various other types such as tubular, ceramic, or flat sheet membranes. The membranes 24 may be oriented vertically or horizontally. Headers 26, which may alternately be called potting heads or tube sheets, may connect a plurality of hollow fibre membranes 24 together. The headers 26 seal the ends of the membranes 24 and either just one or both of the headers 26 connect the permeate sides 25 of the membranes 24 to appropriate piping. Similarly, flat sheet membranes are typically attached to headers or casings that create an enclosed surface on one side of a membrane or membranes and allow appropriate piping to be connected to the interior of the enclosed surface. A header 26 or casing holding one or more membranes may be referred to as a module. A plurality of modules may also be joined together and may be referred to as a cassette, cluster or other similar terms. In this description, however, the words “membrane” and “membranes” may be used to refer to one or more membranes 24 whether or not they are connected in one or more modules, cassettes or other structures.

Referring still to FIG. 1, for hollow fibre membranes 24, the retentate side 27 of the membranes 24 may be the outside of the membranes and the permeate side 25 of the membranes 24 may be their lumens. The permeate sides 25 of the membranes 24 are held in fluid communication with one or both of the headers 26 and together form a membrane module 28 which is connected to a permeate collector 30 and a permeate pump 32 through a permeate valve 34. When permeate pump 32 is operated and permeate valve 34 and an outlet valve 39 opened, a negative pressure is created in the permeate side 25 of the membranes 24 relative to the tank water 22 surrounding the membranes 24. The resulting transmembrane pressure draws tank water 22 through membranes 24 while the membranes 24 reject solids which remain in the tank water 22. Thus, filtered permeate 36 is produced for use at a permeate outlet 38. The transmembrane pressure could alternately be created by pressurizing the tank water 22. The transmembrane pressure may also be provided in the opposite direction, that is towards the outsides of the membranes 24 with the feed provided to the insides of the membranes 24.

The filtered permeate 36 may require post treatment before being used as drinking or process water or discharged at the end of a wastewater treatment process, but should have acceptable levels of solids. The membranes 24 may have an average pore size between 0.003 microns and 10 microns or between 0.02 microns and 1 micron. Suitable membranes include those sold under the ZEEWEED trade mark and produced by Zenon Environmental Inc., for example ZEEWEED 500 or ZEEWEED 1000 membrane products. The total size and number of membranes 24 required varies for different applications depending on factors such as the amount of filtered permeate 36 required and the condition of the feed water 14. Similarly, the preferred transmembrane pressure to be applied to the membranes 24 varies for different membranes and the desired yield but may range from 1 kPa to 100 kPa and may be less than 67 kPa for ZEEWEED hollow fibre membranes 24.

Tank water 22 which does not flow out of the tank 20 through the permeate outlet 38 flows out of the tank 20 through a drain valve 40 in a retentate outlet 42 to a drain 44 as retentate 46. Alternately, or additionally, retentate 46 may travel through retentate outlet 42 to another downstream treatment area or be recycled to water supply 16 or another upstream treatment area. The retentate 46 is rich in the solids rejected by the membranes 24. When producing potable water, the retentate 46 may be sent back to the source that the feed water 14 was originally drawn from. In waste water treatment applications, some of the retentate 46 may be a sludge which is further processed, for example by recycle to the head of the plant, while another part of the retentate 46 is a waste sludge that is disposed of, possibly after thickening or other operations. In drinking water applications, the retentate 46 may be withdrawn from the tank 20 either continuously or periodically. In wastewater applications, the reactor 10 may be operated continuously. In continuous operation, alternately called feed and bleed, although there may be short periodic interruptions for example for cleaning, maintenance or integrity testing procedures, feed water 14 flows into the tank 20 and permeate 36 is withdrawn from the tank over extended periods of time and retentate 46 is withdrawn generally continuously as needed to preserve the required level of tank water 22 in the tank 20. In periodic operation, filtering may occur in a batch mode, or with periods of dead end filtration without retentate 46 withdrawal separated by deconcentration procedures involving draining the tank 20 of retentate 46 and refilling it with new feed water 14. In some drinking water applications, the process operates continuously but for periodic, i.e. once a day, tank drainings for cleaning, maintenance or integrity testing procedures. Other processes may also be used.

During permeation, a permeate tank valve 64 may be opened from time to time to provide permeate 36 in a permeate recycle tank 62. The remainder of the permeate 36 is produced for use or discharge. During permeation, solids accumulate on the surface of the membranes 24 and in their pores, fouling the membranes 24. Various techniques may prevent some of this fouling. Firstly, the membranes 24 may be agitated, for example by mechanically agitating the tank water 22 near the membranes 24 or by supplying a gas to the tank water 22 near the membranes 24. For this, a gas supply system 49 has an gas supply pump 50 which blows a gas, for example ambient air, from an intake 52 through gas distribution pipes 54 to an aerator 56 which disperses gas bubbles 58 into the tank water 22 near the membranes 24. The gas bubbles 58 may be provided continuously or intermittently, and during permeation, backwash or relaxation periods to discourage solids from depositing on the membranes 24. Secondly, backwashing may be used. For this, the membranes 24 are backwashed by closing permeate valve 34 and outlet valve 39 and opening backwash valves 60. Permeate pump 32 draws filtered permeate 36 from the permeate recycle tank 62 and flows permeate 36 through a backwash pipe 63 to the headers 26 and through the walls of the membranes 24 in a reversed direction thus pushing away some of the solids attached to the membranes 24. At the end of the backwash, backwash valves 60 are closed and permeate valve 34 re-opened. Permeate pump 32 may flow permeate 36 back into permeate recycle tank 62 until permeate recycle tank 62 is refilled. Permeate tank valve 64 may be then closed and outlet valve 39 opened. Such backwashing may occur approximately every 15 minutes to 90 minutes for a period of 15 seconds to one minute. Thirdly, relaxation may be used. For this, permeation is stopped temporarily. Agitation may be provided immediately before, or during, or immediately after relaxation or backwashing. Although permeation may be temporarily disrupted, and some permeate 36 may return to tank 20 in some of these processes, a continuous process is still considered continuous and a dead end process is still considered dead end. Permeate 36 may pass through a permeate holding tank 37 to even out disruptions in the flow of permeate 36. Air entrained in the permeate 36 may be collected in an air collector 130 connected to a high point in the permeate lines 30. To remove collected air, an air collector valve 132 may be opened and a vacuum pump 134 operated as required to discharge air collected in the air collector 130.

With backwashing relaxation in the use of gas bubbles 58 to clean the membranes 24 as described above, permeation may continue for an extended period of time, for example 1 or 2 weeks or more, without significant fouling of the membranes. However, despite these methods, over time solids in the tank water 22 may dewater and accumulate, in one or more regions around the membranes 24. This phenomenon may be referred to as “sludging” and it is useful to provide a process to remove, or prevent the accumulation of, solids on the membranes 24 and thereby inhibit or reverse such sludging.

A desludging process may consume an appreciable amount of time, for example 10 minutes or more, and may be performed less frequently than other cleaning steps, for example at a frequency of between about once or twice per day to once per month. A desludging process may also be combined with a chemical cleaning process, which may be performed at a frequency in a similar range or according to a schedule that intersects with the desludging frequency from time to time. The following paragraphs will first describe an example of a chemical cleaning process and them describe an integrated desludging process, although the desludging process may also be performed alone.

A chemical cleaning process may involve contacting the membranes 24 with a chemical cleaner while ordinary permeation is stopped according to a method to be described below. The chemical cleaner used may be any chemical appropriate for the application and not overly harmful to the membranes 24. Typical chemicals include oxidants such as sodium hypochlorite, acids such as citric acid and bases such as sodium hydroxide. The chemical cleaner may be a liquid or may be used in a non-liquid form such as by introducing it as a solid into a volume or flow of water. Liquid chemical cleaners, however, may be easier to handle and inject in the proper amounts.

To contact the membranes 24 with chemical cleaner, permeate valve 34, outlet valve 39 and backwash valves 60 are all closed and permeate pump 32 turned off. The tank water 22 is drained from the tank 20 and the drain valves 40 are closed. Permeate fill pump 120 is operated with permeate fill valve 124 open to flow permeate 36 from permeate recycle tank 62 through permeate fill line 122 to tank 20. Chemical valve 66 is opened and chemical pump 67 turned on pushing chemical cleaner from chemical tank 68 into permeate fill line 122 to mix cleaning chemicals into the permeate 36 flowing to the tank 20. Alternately, cleaning chemicals can be pumped from a chemical tank 68 holding a larger volume of a more dilute cleaning chemical directly into tank 20. When tank 20 is full with a solution of cleaning chemicals and water, permeate fill pump 120 is stopped and permeate fill valve 124 is closed. Sometime between stopping permeation and when the chemical clearer has been added to tank 20, pressurized air valve 114 is opened to allow pressurized air source 110 to deliver pressurized air through pressurized air line 116 to one or both headers 26. During this time, shut off valve 112 is closed. The pressurized air source 110 may be a pump, blower, compressed air tank or other device able to provide a flow of pressurized air or another gas. Pressurized air source 110, and also pressurized air line 116 and valve 114, may also be part of a membrane integrity testing system 118 used to provide air under pressure to the one side of the membranes 24 during integrity tests, for example a pressure decay test. The integrity testing system may provide air at a pressure normally used for integrity testing, for example about 15 psi, or may be modified with a pressure control mechanism to provide air at a lower pressure, for example 10 psi or less, or about 5 psi. Similar pressures may also be provided using other devices. This first purge as described above may be performed before the tank 20 is drained. This prevents dilution of the cleaning chemicals with permeate pushed into the tank during the purge. Further, if the chemical cleaner is optionally heated, performing a first purge before draining the tank 20 and re-filling the tank 20 with cleaning chemical avoids cooling of the cleaning chemical by the purged permeate. Alternately, however, the first purge can be performed after the tank 20 has been drained and partially re-filled with cleaning chemical. The purged permeate is then intentionally used to complete re-filling the tank and bring the cleaning chemical down to a desired concentration.

The pressurized air moves fluids away from or out of the permeate sides 25 of the membranes 24. After a period of time, pressurized air valve 114 is closed. Shut off valve 112, permeate valve 34 and diversion valve 122 are then opened. Permeate pump 32 is operated for a short time to move cleaning chemical from the tank 20 into the pores of the membranes 24 and then stopped. Optionally, shut off valve 112 may be opened but permeate valve 34 and diversion valve 122 left closed. Vacuum pump 134 of the air removal system may then be operated, as required, to move cleaning chemical from the tank 20 into the pores of the membranes 24. Pressurized air may then be applied to the permeate sides 25 of the membranes 24 again, as described above, optionally after a waiting period, to move reacted cleaning chemical out of the pores of the membranes 24. Fresh cleaning chemical is then drawn back into the pores of the membranes 24 using suction by operating the permeate pump 32 or vacuum pump 134 as described above to refresh the cleaning chemical in the pores of the membranes. The steps of moving chemical cleaner into the pores, alternately called a refresh step, and then moving chemical cleaner out of the pores, alternately called a purge step, may be repeated several times. Optionally, a waiting step may be added between the refresh step and the purge step to allow refreshed cleaning chemical more time to react with foulants. It is optional, but not necessary, to fully purge the pores of the membranes 24 of reacted cleaning chemical and provide fresh, unreacted cleaning chemical with each repetition of these steps. The objective is to exchange at least some cleaning chemical that has been reacting with solids or other foulants on the surfaces of the membranes 24 or in their pores with fresh cleaning chemical and/or remove reaction products from near the membranes. In this way, the average concentration of the cleaning chemical over the entire duration of a procedure may be higher than if, for example, the tank 20 or pores of the membranes 24 were filled with cleaning chemical and then simply allowed to soak for some length of time. Further, the purge steps may also provide some physical removal of foulants. The waiting periods between a refresh step and a following purge step, if any, may be 30 seconds or longer, for example between 1 and 6 minutes. Alternately, the process may be generally continuous with refresh and purge steps performed generally right after each other, for example, with a delay between subsequent steps of only long enough to complete and verify valve movements or to provide a safety factor to ensure that purge and refresh steps do not overlap.

During the cleaning procedure, or during the purge and refresh steps of the cleaning procedure, agitation, such as air scouring, may be provided in the tank water 11. This helps disperse partially reacted cleaning chemical being purged from the membranes 24 and bring more nearly unreacted cleaning chemical to the outsides of the membranes 24 to be drawn into the pores during the refresh step. After the desired number of purge, refresh and wait steps have been performed, the tank 20 is drained of the chemical cleaner and refilled with fresh feed water. The drained chemical cleaner may be neutralized and discarded or reused. The concentration of the cleaning chemical may be increased before reuse by concentration or by adding new chemical. Permeate initially produced after returning the membranes 24 to service may be diverted to a drain 44 or to another post treatment or recycling area by allowing permeate outlet valve 39 to be closed and permeate diversion valve 122 to be open for a time until cleaning chemical on the permeate side of the membranes 24 has been removed from the permeate lines 30. The membranes 24 may optionally be backwashed before returning them to service, optionally before draining the tank 20 of chemical cleaner. The backwash may remove cleaning chemical from the permeate sides 25 of the membranes 24 and may also dislodge deposits of solids weakened by the cleaning chemicals.

The waiting period between each suction step and a following purge, if any, may be as long as, for example, between 50 seconds and 6 minutes or about 3 minutes for drinking water applications and about 5 minutes for wastewater applications. The cleaning chemical may be refreshed between 2 and 100 or between 5 and 30 times during a maintenance cleaning event and possibly a greater number of times during recovery cleaning.

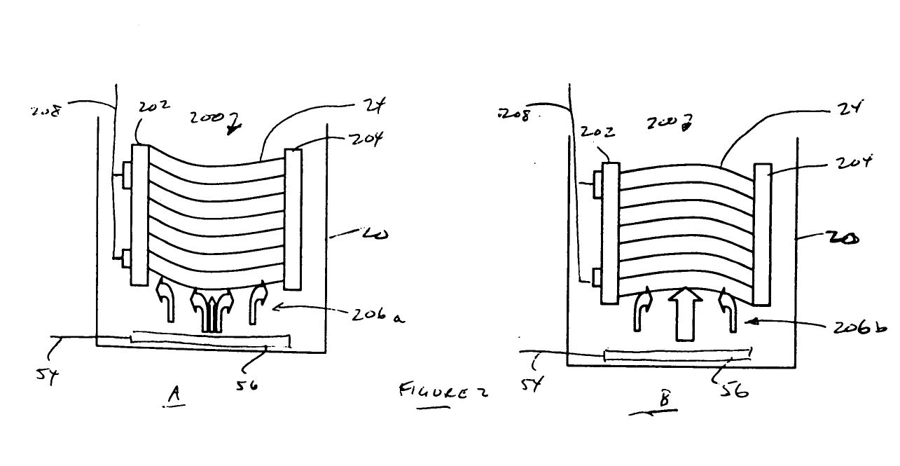

The desludging process will now be described with reference to FIG. 1 and FIG. 2. In FIG. 2 a second module 200 has membranes 24 oriented generally horizontally between a first header 202 and a second header 204 in a tank 20. The ends of the membranes 24 are closed in the second header 204. A connecting pipe 208 connects the first header 202 to a permeate collector and pressurized air line as described for the reactor 10 of FIG. 1. If the second header 204 is also a permeating header, the connecting pipe 208 may be connected to the second header 204 in parallel or one header 202, 204 may be connected to a permeate collector while the other is connected to a pressurized air line or other connections may be made. An aerator 56 connected to a gas distribution pipe 54 can be operated to provide bubbles which rise past and contact the membranes 24. To the extent that they are not inconsistent with any statement regarding FIG. 2, the other parts of the reactor of FIG. 1 are also present in the apparatus of FIG. 2 and the apparatus of FIG. 2 may be operated as described for FIG. 1.

The membranes 24 may be polymeric and may have a density greater than that of water. As a result, as shown in Part A of FIG. 2, the membranes 24, being slightly longer than the horizontal distance between headers 202, 204, may sag downwards when their lumens are filled with water even in the presence of bubbles rising from aerator 56. The concave upwards curvature of the membranes 24 encourages the bubbles or entrained tank water to flow in a first pattern 206a. In first pattern 206a, flow paths are angled towards the headers 202, 204, the size of this angle being exaggerated in FIG. 2 for illustration purposes. When the lumens of the membranes 24 are filled with air, the membranes 24 become buoyant or nearly buoyant such that they rise towards the top of tank 20 at least when under the influence of bubbles rising from aerator 56 as shown in Part B of FIG. 2. The concave downwards shape encourages the bubbles or entrained tank water to flow in a second pattern 206b. In second pattern 206b, flow paths are angled towards the middle of second module 200. The size of this angle is exaggerated in FIG. 2 for purposes of illustration. The flow path towards the middle of second module 200 encourages bubbles to rise through the middle of second module 200 and counters a tendency of bubbles to move towards headers 202, 204 where the membranes 24 are less able to move and horizontal spacers or channels may exist. This may improve the distribution of the bubbles.

A process for cleaning the membranes 24 of second module 200 may involve some or all of the steps described below. Some or all of the steps described below may also be used with the reactor 10 of FIG. 1. Although the shape of the membranes 24 of reactor 10 may not change to the extent described below, the membranes 24 may have an excess length and change shape despite their vertical orientation or the process steps described below may be used for other reasons, for example to clean the membranes 24, to conduct an integrity test or to deconcentrate, that is remove a significant percentage of the solids, for example 20% or more, from the tank 20. Regardless of the orientation of the membranes 24, a more buoyant, or more nearly buoyant, membrane 24 may move to a greater extent in response to bubbles or tank water motion and the gas pressure inside the membranes, although less than the bubble point of the membranes 24, may help loosen solids from the pores of membranes 24 even if the gas does not form bubbles through most, or any, of the pores of membranes 24. This may allow the bubbles to flow past the retentate side of the membranes 24 to be more effective.

After a period of permeation, permeation is stopped and the lumens of membranes 24 are filled, or at least partially filled, with a pressurized gas, for example air, optionally in preparation for an integrity test, such as a pressure decay test. While a pressurized gas is inside the membranes 24 and the water in the tank 20 is above the level of the membranes 24, the membranes 24 are aerated by bubbles from aerator 56. Optionally, this aeration may continue while the tank 20 is drained or filled or be performed with the tank water 22 surface at other elevations, for example an elevation intersecting or just above an area of sludge accumulation. While the water in the tank 20 is below the membranes 24, an integrity test, such as an empty tank pressure decay test, may be performed. After the integrity test, the tank 20 may be filled with a chemical cleaning solution. When the cleaning solution is above the membranes 24, the gas inside the membranes 24 may be vented, for example by opening vent valve 210 in outlet 212 shown in FIG. 1. Alternately, the permeation system can be used to reduce the pressure inside the membranes 24. The pressurized gas may then be alternately pushed into the lumens of the membranes 24 and then vented, or depressurized through the permeate system, to cause old cleaning solution to move from the lumens of the membranes at least partially into the pores and then pull cleaning solution back into the lumens thus pulling fresh cleaning solution from the tank back into the pores of the membranes 24. Liquid, such as permeate, may also be used to periodically or cyclically move cleaning solution from the lumens to the pores, although a gas moves old cleaning solution into the pores, thereby purging the pores, more nearly equally from the top and bottom of a module. After the chemical cleaner has been purged and refreshed through a desired number of cycles, or a desired chemical contact time has been reached, the insides of the membranes 12 may be pressurized again to remove cleaning solution from the pores of the membranes 24. The tank 20 may then be emptied of cleaning solution and refilled with feed water. The membranes 24 may be aerated during either or both of the emptying or filling. The tank 20 may be drained again, optionally while aerating the membranes, to rinse tank 20 or provide further cleaning by way of aeration. The tank 20 may then be refilled with feed water and permeation restarted. The pressure inside of the membranes 24 is released before starting permeation so that water can flow into the pores of the membrane. This pressure release can be done before, during or after the final fill of the tank 20 before starting permeation. Gas in membranes 24 can be allowed to flow beyond a connection of connector pipe 208 with the permeate system, for example by leaving vent valve 200 open while tank 20 is filled or being filled for a sufficient time, or air entrained after starting permeation can be captured and later purged through air collector 130 and its related components. The process described above may be performed, for example, without performing either or all of an integrity test, a tank draining or chemical cleaning. For example, pressurized gas may be added to the inside of membranes 24 at any time that the membranes 24 are aerated. Alternately, pressurized gas maybe added to the insides of membranes 24 only when such membranes 24 are aerated while the tank 20 is being fully or partly drained, for example, according to a desludging process described in International Publication No. WO 2005/082498.

In the following examples, a membrane filter, in particular a filter with Zenon ZW 1000 modules having a configuration as shown in FIG. 2, was operated for a period of time until portions of the filter had sludge deposits. The filter was then desludged by draining the membrane tank, refilling the tank with permeate, aerating the filter at 3 dcfm for 20 minutes with the tank full and then slowly draining the tank while still providing bubbles. The aeration during draining is believed to be effective at carrying solids loosened by the previous full tank aeration out of the filter and to the drain. Without returning the filter to permeation, the filter was then put through a second cleaning cycle in which the tank was refilled with permeate, and the filter was aerated again for 20 minutes and while draining. In some trials, the tank was then refilled a third time, the filter aerated again for 20 minutes and then while the tank is drained. In the first cycle, the membranes were scoured for 20 minutes while their lumens are filled with permeate.

In the second cycle, the membranes were filled with air pressurized to 10 psi while they were scoured by bubbles for 20 minutes. In the third cycle, the membranes were scoured while having permeate in their lumens. After each drain, the total suspended solids (TSS) concentration in the drained water was measured. TSS concentration in the drained water indicates the extent which a desludging process removed solids from the membranes.

### EXAMPLE 1

| | |
|---|---|
| Feed | Baywater with 5 ppm PACI (as PACI) |
| Module: | Three modules stacked vertically, 600 sq ft each |
| Solids Accumulation: | Thick accumulation along the headers of the top |
| | and middle modules |

| | Sample 1 | Sample 2 | Avg |
|---|---|---|---|
| Cycle 1 | | 36 | 36 |
| (permeate in lumens) | | | |
| Cycle 2 | | 65 | 65 |
| (with air in lumens) | | | |

### EXAMPLE 2

| | |
|---|---|
| Feed | Settled water |
| Module: | Three modules stacked vertically, 675 sq ft each |
| Solids Accumulation: | Moderate along the header of the top module; |
| | minor at the bottom of the bottom module |

| | Sample 1 | Sample 2 | Avg |
|---|---|---|---|
| Cycle 1 | 82 | 90 | 86 |
| (permeate in lumens) | | | |
| Cycle 2 | 79 | 80 | 79.5 |
| (with air in lumens) | | | |
| Cycle 3 | 33 | 33 | 33 |
| (permeate in lumens) | | | |

### EXAMPLE 3

| | |
|---|---|
| Feed | Bay water 30 ppm PACI (as PACI) |
| Module: | Three modules stacked vertically, Top module |
| | 600, Middle and Bottom 500 sq ft |
| Solids Accumulation: | Top module heavily sludged, bottom and |
| | middle relatively clean with minor |
| | accumulation along the headers |

| | Sample 1 | Sample 2 | Avg |
|---|---|---|---|
| Cycle 1 | 400 | 391 | 395.5 |
| (permeate in lumens) | | | |
| Cycle 2 | 572 | 587 | 579.5 |
| (with air in lumens) | | | |
| Cycle 3 | 400 | 403 | 401.5 |
| (permeate in lumens) | | | |

In these examples, visual observation and the TSS concentration measurements indicated that lumens in a first cycle removed some of the solids in the tank or on the membranes but more sludge deposits remained in parts of the modules. The aeration with air in the lumens was effective at removing at least parts of these resistant sludge deposits. For example, in Example 3, it was visually apparent after the second cycle that aeration with air in the lumens had removed significant portions of the sludge deposits. The third cycle removed further portions of these same sludge deposits. The inventor believes that the third cycle was able to remove parts of sludge deposits that survived the first cycle mainly because the second cycle had broken down chunks of solids in the top module.

What has been described are examples of one or more methods or apparatuses. The inventions claimed below are not limited to those examples.

I claim:

1. A process for cleaning one or more membranes comprising steps of:
a) providing a gas in a cavity defined by an interior part of the one or more membranes at a pressure below the bubble point of the one or more membranes; and,
b) while performing step (a), providing bubbles in water in the tank from outside of the one or more membranes which bubbles rise past and contact at least a part of the exterior of the one or more membranes.

2. The process of claim 1 wherein the one or more membranes are hollow fiber membranes and the cavity comprises the lumens of the one or more membranes.

3. The process of claim 2 wherein the one or more membranes are oriented generally horizontally.

4. The process of claim 1 further comprising, after steps (a) and (b), draining the water from the tank and refilling the tank.

5. The process of claim 4 wherein bubbles are provided in the water in the tank while draining the tank.

6. The process of claim 1 wherein step (b) occurs for at least 15 minutes.

7. The process of claim 1 wherein the water in the tank is above the entire exterior surface of the one or more membranes during step (b).

8. The process of claim 1 wherein the tank is being drained or filled during step (b).

9. The process of claim 1 further comprising performing an integrity test of the one or more membranes.

10. The process of claim 1 further comprising contacting the one or more membranes with a chemical cleaner.

11. The process of claim 1 performed between twice per day and once per month.

12. The process of claim 1 performed in combination with a feed and bleed fileration process.

13. The process of claim 1 performed in combination with a batch fileration process.

14. The process of claim 1 wherein the water level is near, at, or above an area of sludge accumulation on the one or more membranes.

15. The process of claim 1 wherein water in the tank is at a level below the top of the one or more membranes during step (b).

16. The process of claim 15 wherein the water level is generally constant during step (b).

17. The process of claim 1 wherein the pressurized gas is provided from a gas supply that also supplies gas to a membrane integrity testing system.

18. The process of claim 1 wherein the one or more membranes are essentially all of the membranes in the tank.
